(19) United States
(12) Patent Application Publication
(10) Pub. No.: US 2003/0133012 A1
(43) Pub. Date: Jul. 17, 2003

(54) OBSERVATION SYSTEM

(76) Inventors: PETER J. T. VAN RAVENSTEIN, EINDHOVEN (NL); CHRISTIAN C. M. VISSCHERS, EINDHOVEN (NL)

Correspondence Address: PHILIPS ELECTRONICS NORTH AMERICAN CORP, 580 WHITE PLAINS RD, TARRYTOWN, NY, 10591, US

(21) Appl. No.: 09/304,552

(22) Filed: May 4, 1999

(30) Foreign Application Priority Data
May 8, 1998 (EP) 98201510.9

(51) Int. Cl. H04N 7/18

(52) U.S. Cl. 348/143; 348/153; 348/758

(57) ABSTRACT

In an observation system, comprising an observation camera (A, B, C, D), and an observation monitor unit (CU, M) coupled to the observation camera (A, B, C, D), upon the occurrence of a for observation purposes relevant event (doorbell DB) a plurality of preferably sub-sampled images including an image at a time of the event are recorded and a sequence (E) formed by the plurality of images is repeatedly displayed.

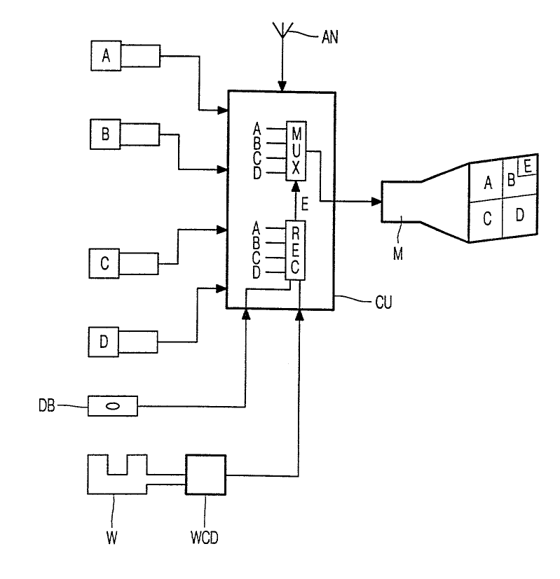

The invention relates to an observation system, and to an observation monitor.

In prior art observation systems, a plurality of observation cameras (e.g. 4) are connected to a single observation monitor. Possibly, it is even possible to display ordinary television signals on the observation monitor. Most of the times, nothing happens on the monitor screen, so that the guard gets bored and does other things such as reading a book or a magazine, or watching a football game. It is thus possible that important events are missed.

It is, inter alia, an object of the invention to provide an observation system and an observation monitor which do not suffer from the above-mentioned disadvantage. To this end, a first aspect of the invention provides an observation system as defined by claim 1. A second aspect of the invention provides a method of observing a complex as defined by claim 5. A third aspect of the invention provides an observation monitor control unit as defined by claim 6. Advantageous embodiments are defined in the dependent claims.

In an observation system in accordance with a primary aspect of the present invention, comprising an observation camera and an observation monitor unit coupled to the observation camera, upon the occurrence of a for observation purposes relevant event (e.g. a ringing doorbell) a plurality of preferably sub-sampled images including an image at a time of the event are recorded and a sequence formed by the plurality of images is repeatedly displayed.

The invention solves the mentioned problem that relevant events may be missed, in that a for observation purposes relevant event is detected, and a sequence of images including an image at the time of that event is repeatedly replayed on an observation monitor. This will draw the guard's attention, so that appropriate action is taken. The event may, for example, be a doorbell, a cable cut, an alarm contact, or a movement detection.

Preferably, the displayed image sequence includes images preceding the event. If 8 seconds are stored at a 2 frames per second rate, the sequence preferably comprises 4 seconds before and 4 seconds after the event.

Advantageously, the sequence is displayed in PIP form, which is a more attention-drawing format and which needs less storage memory.

Preferably, in the case of multiple events, a sequence including a latest of the multiple events is repeatedly displayed.

These and other aspects of the invention will be apparent from and elucidated with reference to the embodiments described hereinafter.

The drawing shows an embodiment of an observation system in accordance with the present invention

In the drawing, four cameras A, B, C, D are coupled to a control unit CU. The control unit CU may further receive an antenna signal from an antenna AN thru a tuner (not shown) to allow the guards to watch a football game or something like that. In accordance with the present invention, the control unit CU also receives a doorbell signal from a doorbell DB, an alarm signal from a wire cut detector WCD detecting whether a wire W is cut, and/or a movement detection signal from a movement detector (not shown). In this embodiment, it is supposed that camera A watches the doorbell DB, while camera B watches the wire W. An output of the control unit CU is coupled to a monitor M for displaying the camera signals A, B, C, D (all four together or a selected one of them), or the football match from the antenna AN.

If the doorbell DB is pressed (or some other for observation purposes relevant event occurs), the control unit CU stores a small sequence of images (e.g. 16 images at a rate of 2 images per second), preferably half of which precedes the doorbell-pressing action and half of which follows the doorbell-pressing action. This is possible if the images from the cameras are continuously applied to a storage unit (not shown) and stored upon activation of the doorbell DB or upon some other activity, or if the images of the cameras are continuously spatially and temporally subsampled and delayed, and stored immediately upon receipt of an alarm. The delayed signal is then stored and will show some seconds preceding the alarm as well as some seconds following the alarm. The subsampled images are shown in a picture-in picture (PIP) window E on the display screen of the monitor M. Preferably, a known photo-finish PIP IC or IC set is used for this purpose. While in the drawing, the PIP image E is shown inserted into image B from camera B among images A, C, D from cameras A, C, D, it is also possible that image E pops up while a football match is shown on the monitor M, or that the monitor M automatically switches over from displaying images received by the antenna AN to (one of) the camera images A, B, C, D with PIP image E repeatedly showing the relevant event.

A practical embodiment is briefly summarized as follows. The invention can be applied in a low-cost black and white observation system. In this observation system there will be an event replay (store and replay) function. If there is an event (doorbell or alarm) then the observation system stores 4 seconds before the event and 4 seconds after the event in a PIP memory. In case of a cable cut disconnecting a camera from the control unit, the last 8 eight seconds before the event occurs, will be stored. During storage of the frames it will display at the same time the frames, in a small (⅛ size) PIP in the right top corner of the screen, in a sequential loop, the stored frames. The displaying speed is at the store sample rate. If there is an event, this replay function will be started automatically after detecting such an event. In case of multiple events on multiple cameras, the system will always switch to the camera corresponding to the latest event, and this latest event will be stored and replayed. The replay function starts with the oldest stored frame. In 50 and 60 Hz systems the number of stored frames is 16.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements than those listed in a claim. The invention can be implemented by means of hardware comprising several distinct elements, and by means of a suitably programmed computer. In the device claim enumerating several means, several of these means can be embodied by one and the same item of hardware. Where the claim mentions an observation camera and an observation monitor, several of these cameras and/or monitors may be present in the observation system. The sequence can be displayed temporally subsequently in one PIP section E on the display, or as e.g. 16 small pictures spatially adjacent to each other. The control unit CU and the monitor M may be included in one apparatus, or may be sold as separate units as shown in the drawing.

1. An observation system, comprising:
an observation camera (A, B, C, D); and
an observation monitor unit (CU, M) coupled to said observation camera (A, B, C, D); characterized by:
means (DB, WCD) for detecting a for observation purposes relevant event; and wherein
said observation monitor unit (CU, M) comprises:
recording means (REC) for recording a plurality of images including an image at a time of said event;
means (M) for repeatedly displaying a sequence (E) formed by said plurality of images upon said event.

2. An observation system as claimed in claim 1, wherein said plurality of images includes images preceding said event.

3. An observation system as claimed in claim 1, wherein said sequence is displayed in PIP form (E).

4. An observation system as claimed in claim 1, wherein in the case of multiple events, a sequence including a latest of said multiple events is repeatedly displayed.

5. A method of observing a complex, the method including:
using at least one observation camera (A, B, C, D) and an observation monitor unit (CU, M) coupled to said at least one observation camera (A, B, C, D); characterized by:
detecting (DB, WCD) a for observation purposes relevant event;
(CU) a plurality of images including an image at a time of said event; and
repeatedly displaying (M) a sequence (E) formed by said plurality of images upon said event.

6. An observation monitor control unit (CU), comprising:
means for receiving camera signals (A, B, C, D);
means for receiving event detection signals (DB, WCD) indicating a for observation purposes relevant event;
means (REC) for recording a plurality of sub-sampled images including an image at a time of said relevant event to repeatedly supply a sequence formed by said plurality of sub-sampled images.
